(19) United States
(12) Patent Application Publication
(10) Pub. No.: US 2009/0017250 A1
(43) Pub. Date: Jan. 15, 2009

(54) FIXING APPARATUS

(76) Inventor: Charles Worthington Kaylow, Nr Wigan (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/097,070

(22) PCT Filed: Nov. 22, 2006
(86) PCT No.: PCT/GB2006/004341

§ 371 Date: Sep. 25, 2008

(30) Foreign Application Priority Data
Dec. 20, 2005 (GB) 0525856.1
Oct. 18, 2006 (GB) 0620692.4

(51) Int. Cl. A47G 1/17; B32B 33/00

(52) U.S. Cl. 428/42.2; 24/67 AR; 427/208.6

(57) ABSTRACT

A fixing apparatus (1, 2, 3) is provided to facilitate temporary or semi-permanent fixing of items such as posters, photographs or notices to a surface such as a wall. The fixing apparatus (1, 2, 3) comprises an adhesive element (20), preferably a piece of adhesive putty sandwiched between cover elements (11, 12). In use the adhesive element (20) can be accessed through an opening (13, 14) in the cover elements (11, 12).

### FIELD OF THE INVENTION

The present application relates to fixing apparatus, to sheets and rolls of fixing apparatus, to methods of fixing, and to methods of manufacturing fixing apparatus.

### BACKGROUND TO THE INVENTION

A commonly used technique for releasably fixing items such as posters, photographs, notices etc. to surfaces involves the use of re-usable adhesive putty. The putty is normally supplied in sheet form, with a user able to tear off a suitably sized blob or blobs of putty. The blobs are kneaded into a suitable shape for fixing, and then squashed between the surface and the item to be fixed.

This technique has a number of disadvantages. Firstly, users typically tear off large blobs of putty, which is wasteful and may lead to dissatisfaction with the price of the putty if a sheet of putty is used up quickly.

Secondly, large blobs of putty can be hard to pull from the sheet and knead into shape, which is a problem for some users.

Thirdly, if accidentally dropped onto the floor it is easy for a blob of putty to be trodden into the floor surface. It can be very difficult to remove blobs of putty from some floor surfaces, e.g. carpet, after they have been trodden in.

Fourthly, large blobs of putty may leave greasy marks on the surface to which they have been adhered as over time solvent diffuses out of the adhesive.

Fifthly, is can be difficult to manipulate blobs of putty, as the adhesive nature of the putty means it can stick to a user's hands.

Finally, a large blob of putty may form a strong very bond with the surface or the item to be fixed to the surface, which can damage either the surface or the item when the two are separated.

It is an aim of preferred embodiments of the present invention to address at least one of the disadvantages of the prior art, whether identified herein or otherwise.

### SUMMARY OF THE INVENTION

According to a first aspect of the present invention there is provided a fixing apparatus comprising an adhesive element positioned between first and second cover elements, wherein the first cover element has: (a) a predetermined line or point of weakness defined therein, wherein breaking of the first cover element at the predetermined line or point of weakness defines an opening in the cover elements; to allow access to the adhesive element therethrough; or (b) an opening therein to allow access to the adhesive element there-through, and wherein the second cover element has: (a) a predetermined line or point of weakness defined therein, wherein breaking of a cover element at the predetermined line or point of weakness defines an opening in the cover element to allow access to the adhesive element there-through; or (b) an opening therein to allow access to the adhesive element there-through.

Suitably, the fixing apparatus comprises a laminar structure. Suitably, the first and second cover elements comprise flexible sheet material. Suitably, the first and second cover elements comprise a paper material, a waxed paper material, a greaseproof paper material, a vinyl material or a plastics material. The first and second cover elements may comprise portions of different materials.

Suitably, the first and/or second cover element comprises a ring like shape, preferably a circular ring like shape. Suitably, the openings are closed or open-mouthed. Suitably, the first and second cover elements may be substantially identical in shape. Suitably, the cover elements have reflective and/or circular symmetry.

Suitably, each of the cover elements comprises an inner surface proximate to the adhesive element, the inner surface of one or both of the cover elements comprising an adhesive surface. Suitably, the cover elements are held in place relative to the adhesive element by one or both of the adhesive properties of the adhesive element and the adhesive properties of a cover element. Suitably, portions of the inner surface of the cover elements not in contact with the adhesive element stick to one another by virtue of the adhesive properties of the inner surface of a cover element. Suitably, the cover elements may be held together by heat fusion or sewing.

Suitably, the first and/or second cover elements may each further comprise a guard element positioned in the opening in the cover element. Suitably, the guard element may substantially fill the opening in the cover element. Suitably, the or each guard element is held in place by contact with the adhesive element. Suitably, the or each guard elements is coupled to the cover element at a predetermined line, point or points of weakness, the predetermined line, point or points or weakness defining the opening and the guard element when the cover element is broken at the predetermined line, point or points of weakness. Suitably, the guard element may be hingedly connected to the cover element when the cover element is broken at the predetermined line, point or points of weakness.

Suitably, the adhesive element is in contact with and adheres to the cover elements. Suitably, the adhesive element is in contact with and adheres to an area of the cover elements peripheral to the opening therein. Suitably, the adhesive element comprises a lamina of adhesive material. Suitably, the adhesive element comprises adhesive putty.

Suitably, the cover elements comprise a printable surface portion, able to receive a printed or written message. Suitably, the printable surface portion may comprise a reflective, fluorescent or phosphorescent material or surface coating.

According to a third aspect of the present invention there is provided a plurality of fixing apparatus of the first or second aspect, provided on a sheet or provided on a roll.

Suitably, the plurality of fixing apparatus are provided in a two dimensional array on the sheet or the roll. Suitably, the sheet is a flat sheet.

According to a fourth aspect of the present invention there is provided a method of fixing comprising use of the fixing apparatus of the first or second aspect.

According to a fifth aspect of the present invention, there is provided a method of manufacturing a fixing apparatus, the method comprising providing first and second cover elements, one or both of the cover elements having an opening therein; and providing an adhesive element between the cover elements such that the adhesive element can be accessed through an opening of a cover element.

According to a sixth aspect of the present invention there is provided a method of manufacturing a fixing apparatus, the method comprising providing first and second cover elements, wherein one or both of the cover elements has a predetermined line or point of weakness defined therein; and providing an adhesive element between the cover elements such that breaking of a cover element at the predetermined line or point of weakness defines an opening in the cover element to allow access to the adhesive element therethrough.

### BRIEF INTRODUCTION TO THE DRAWINGS

For a better understanding of the invention, and to show how embodiments of the same may be carried into effect, reference will now be made, by way of example, to the accompanying diagrammatic drawings in which:

FIG. 1 shows a front view of a fixing apparatus according to a first preferred embodiment of the present invention, with hidden detail shown to aid understanding;

FIG. 2 shows a front view of the fixing apparatus of FIG. 1;

FIG. 3 shows an exploded perspective view of the fixing apparatus of FIG. 1,

FIG. 4 shows a front view of a fixing apparatus according to a second preferred embodiment of the present invention, with hidden detail shown to aid understanding;

FIG. 5 shows a front view of the fixing apparatus of FIG. 4;

FIG. 6 shows an exploded perspective view of the fixing apparatus of FIG. 4;

FIG. 7 shows a front view of a fixing apparatus according to a third preferred embodiment of the present invention, with hidden detail shown to aid understanding;

FIG. 8 shows a front view of the fixing apparatus of FIG. 7; and

FIG. 9 shows an exploded perspective view of the fixing apparatus of FIG. 7.

### DESCRIPTION OF PREFERRED EMBODIMENTS

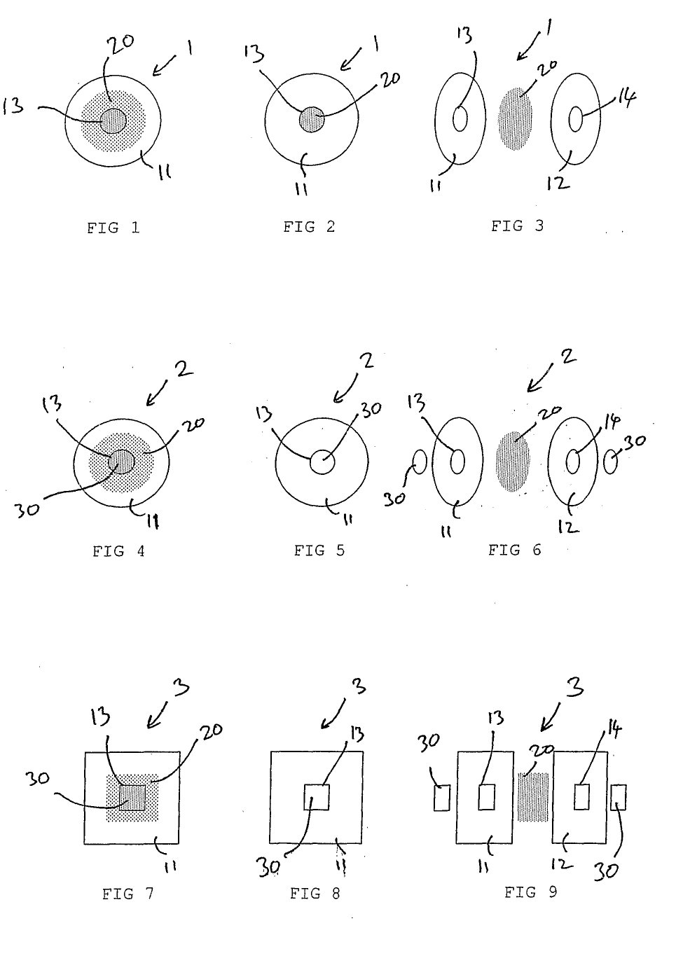

Referring to FIGS. 1-3 there is shown a fixing apparatus 1 according to a first preferred embodiment of the present invention. The fixing apparatus 1 comprises first and second cover elements 11,12, and an adhesive element 20.

Each of the first and second cover elements 11,12 comprises a ring of a flexible sheet material such as waxed paper, defining openings 13,14 there-through respectively. The adhesive element 20 comprises a pad of adhesive putty.

The adhesive element 20 is sandwiched between the cover elements 11,12 so that it is accessible through the openings 13,14.

It is easy to use the fixing apparatus 1 to secure an item to a surface. A user can pick up and position the fixing element 1 by grasping the cover elements 11,12. The user does not have to directly touch the adhesive element. The user can position the fixing apparatus 1 on the surface or item, and can then press the surface and the item together with the fixing apparatus there-between. This compresses the adhesive element, forcing adhesive into contact with both the surface and the item and thereby holding the surface to the item.

When fixing an item such as poster, photograph or notice to a surface it is possible for a user to hold the fixing apparatus against the back of the item with one or more fingers and to use his thumb to hold the fixing apparatus in a desired position relative to the item. For example, it may be desired to hold the fixing apparatus in position near an edge or corner of the item. The user can press the item to fixing apparatus and the fixing apparatus to the surface as his fingers are removed from between the fixing apparatus and the surface by bending the item and the fixing apparatus.

Although the examples herein relate to the use of a fixing apparatus to secure an item to a surface, it is to be understood that the fixing apparatus described can also be used to fix items to one another, and in various other ways.

The cover elements extend beyond the area of the adhesive element so that there is room between the cover elements for the adhesive element to expand laterally as the fixing apparatus is compressed axially. Ideally, the cover elements extend sufficiently beyond the adhesive elements so that in normal use a user will not be able to compress the fixing apparatus so far that adhesive extends out beyond the cover elements.

In other preferred embodiments, the inner surface of one or both of the cover elements can be made adhesive, so that the adhesive element is held strongly in place between the cover elements. In such embodiments, portions of the cover elements away from the adhesive element can stick to one another to thereby hold the fixing apparatus together. The cover elements can be held together in other ways, for example by heat fusion at their out edge, by sewing or using other suitable techniques. In such embodiments the adhesive is held within the outer periphery of the cover elements.

Although the adhesive element is preferably an adhesive putty or other malleable adhesive, other adhesive elements may be used, for example pads or sheets or pressure sensitive adhesive, or of other tacky materials.

FIGS. 4-6 show a second embodiment of fixing apparatus 2 which is provided with guard elements 30. The guard. elements 30 locate in the openings 13,14 in the cover elements 11,12, and when so located substantially fill the openings 13,14. The guard elements 30 are held-in place in the openings 13,14 by contact with the adhesive element 20. The guard elements are used to protect the adhesive element before use of the fixing apparatus, and prevent the fixing element from adhering to its packaging etc. The guard elements may also form part of a simplified manufacturing process for the fixing apparatus. The guard elements may also form part of a printable surface of the fixing apparatus, as described in more detail below.

When a use wishes to use the fixing apparatus 2, the first stage is for the guard elements 30 to be peeled off from the adhesive element 20. The guard elements can be discarded, or alternatively can be retained for future re-use. In other preferred embodiments the predetermined line or points of weakness may not be sufficient to allow a user to break the guard elements completely away from the cover elements. The guard elements can in such embodiments pivot away from the opening on a flap of cover element material which does not form part of the predetermined line or points of weakness. The guard elements are retained with the cover elements for future use re-covering the adhesive element. Once the guard elements 30 have been removed or moved to uncover the openings 13, 14, the fixing apparatus 2 can be used in the same way as the embodiment of FIGS. 1-3.

As mentioned above, the guard elements may be formed as part of a manufacturing process, in which a die, stamp or other tool cuts the guard elements from the cover elements. In preferred embodiments the inner surfaces of the guard elements, i.e. those in contact with the adhesive element 20, are not adhesive. This facilitates separation of the guard elements from the fixing apparatus.

In other embodiments, the opening or openings may be defined by predetermined lines or points of weakness made in the cover members. A user removes the guard elements by tearing or otherwise breaking the cover elements at the lines or points of weakness, thereby forming the openings.

FIGS. 7-9 show a third embodiment of fixing apparatus 3 similar to that of FIGS. 4-6, but of a generally square shape rather than a generally circular shape. Other shapes of fixing apparatus are envisaged. For example, regular polygonal shapes are possible, as are irregular polygonal shapes, re-entrant shapes, shapes with curved edges, etc. It is also possible for the shape of the adhesive element to be different to the shape of the cover elements, for the shape of the openings to be different from that of outer edge peripheral of the cover members, and for the cover elements to be different shapes from one another.

Although the embodiment shown in the drawings comprise cover elements which comprise closed, ring like openings, other shapes are possible for the openings. For example, C or U shaped cover elements may be used. In these embodiments, the opening in the cover elements is an open-mouthed opening. Such embodiments do not have the advantages of radial symmetry, but may be advantageous in other ways, e.g. when applying the fixing apparatus to an item/surface.

It will be appreciated ;that simple geometric shapes such as the generally circular and square embodiments shown have advantages in terms of ease of manufacture and aesthetic appeal.

Particularly preferred embodiments of the fixing apparatus comprise cover elements with a printable surface portion, able to receive a printed or written message. This enables a user to decorate the fixing apparatus, or alternatively the fixing apparatus can be used as a promotional or advertising item. The printable surface portion may comprise the area of the cover elements around the opening, and may further comprise the guard elements. The printable area may comprise a reflective, fluorescent or phosphorescent surface which can make it easier for a user to find the fixing apparatus.

The fixing apparatus can be manufactured in sheets built up layer by layer, and can be supplied in sheets or on a roll. The sheets used to make up the fixing elements may be packaged between protective layers ready for use.

The user need not directly touch the adhesive element when using the fixing apparatus. This reduces inconvenience associated with adhesive sticking to a user's hands, while maintaining the relative flexibility of use and adaptability associated with adhesives such as adhesive putty.

Since the fixing apparatus is of a predetermined size, a user can easily and accurately judge the number of fixing apparatuses available in a pack, and can more easily estimate the number of fixing apparatus or packs of fixing apparatus required to fix a number of items. Furthermore, the fixing apparatus is provided with a suitable amount of adhesive to enable good fixing without unnecessary extra adhesive. Also, kneading of the adhesive can be dispensed with because the fixing apparatus and adhesive therein is preformed to a suitable size and shape for normal usage.

Use of a suitable amount of adhesive prevents an overly strong bond being formed, which is particularly useful in cases where a temporary fixing is needed and the surface and/or item are relatively fragile. Also, the amount of solvent which can leach out of the adhesive is limited. Preferred embodiments of the fixing apparatus are in the range of 10-15 mm in diameter for generally circular shaped apparatus, and similar outside dimensions for non-circular shaped apparatus. In such embodiments the openings are preferably 4-6 mm in diameter for generally circular shaped openings, and similar dimensions for non-circular shaped openings. Embodiments of these dimensions are effective in fixing an item such as a regularly sized rectangular poster, photograph, notice etc. to a vertical surface using four fixing apparatus located one at each corner of the item. Embodiments of these dimensions are also easy to manipulate.

If a fixing apparatus is dropped onto the floor, the cover elements prevent the adhesive element from coming into contact with the floor. If a fixing apparatus is trodden on, the distributed pressure across the cover elements and the adhesive element is unlikely to force the adhesive element into close contact with the floor surface. In this way the risk of adhesive material being trodden into the floor surface is reduced. This is particularly evident for floor surfaces which can deform under pressure, such as e.g. carpet, as the carpet deforms rather than the adhesive being forced into contact with the carpet.

Furthermore, the presence of one cover element between a portion of the adhesive element and the floor surface makes it relatively easy to peel the adhesive from the floor surface by carefully lifting the cover member which is adjacent to the surface. As the adhesive is supported all around by the cover element it can be peeled off easily in one piece. This method of removal of fixing apparatus is also useful when removing fixing apparatus from other surfaces/items.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A fixing apparatus comprising an adhesive element positioned between first and second cover elements, wherein the first cover element has:
(a) a predetermined line or point of weakness defined therein, wherein breaking of the first cover element at the predetermined line or point of weakness defines an opening in the cover elements to allow access to the adhesive element therethrough; or
(b) an opening therein to allow access to the adhesive element there-through; and
wherein the second cover element has:
(a) a predetermined line or point of weakness defined therein, wherein breaking of the second cover element at the predetermined line or point of weakness defines an opening in the cover element to allow access to the adhesive element there-through; or
(b) an opening therein to allow access to the adhesive element there-through.

2. The fixing apparatus of claim 1 comprising a laminar structure.

3. The fixing apparatus of claim 1 wherein the first and second cover elements comprise flexible sheet material.

4. (canceled)

5. The fixing apparatus of claim 1, wherein the first and/or second cover element comprises a ring like-shape.

6. (canceled)

7. The fixing apparatus of claim 1, wherein the first and second cover elements are substantially identical in shape.

8. (canceled)

9. (canceled)

10. (canceled)

11. The fixing apparatus of claim 1, wherein the cover elements are held in place relative to the adhesive element by the adhesive properties of the adhesive element.

12. (canceled)

13. (canceled)

14. (canceled)

15. The fixing apparatus of claim 1 wherein the first and/or second cover elements each comprise an opening, and further comprises a guard element positioned in the opening in the cover element.

16. The fixing apparatus of claim 15, wherein the guard element substantially fills the opening in the cover element.

17. The fixing apparatus of claim 15, wherein the or each guard element is held in place by contact with the adhesive element.

18. The fixing apparatus of claim 15, wherein the or each guard elements is coupled to the cover element at a predetermined line, point or points of weakness, the predetermined line, point or points or weakness defining the opening and the guard element when the cover element is broken at the predetermined line, point or points of weakness.

19. The fixing apparatus of claim 18, wherein the guard element is hingedly connected to the cover element when the cover element is broken at the predetermined line, point or points of weakness.

20. (canceled)

21. (canceled)

22. (canceled)

23. The fixing apparatus of claim 1, wherein the adhesive element comprises adhesive putty.

24. (canceled)

25. (canceled)

26. A plurality of fixing apparatus of claim 1, provided on a sheet or provided on a roll.

27. (canceled)

28. (canceled)

29. (canceled)

30. A method of manufacturing a fixing apparatus, the method comprising providing first and second cover elements, both of the cover elements having an opening therein; and providing an adhesive element between the cover elements such that the adhesive element can be accessed through an opening of a cover element.

31. A method of manufacturing a fixing apparatus, the method comprising providing first and second cover elements, both of the cover elements have one of (a) a predetermined line or point of weakness defined therein; or (b) an opening and providing an adhesive element between the cover elements such that breaking of a cover element at the predetermined line or point of weakness defines an opening in the cover element to allow access to the adhesive element therethrough, or the opening allowing access to the adhesive element there-through.

32. (canceled)
